(19) United States
(12) Patent Application Publication
(10) Pub. No.: US 2007/0157124 A1
(43) Pub. Date: Jul. 5, 2007

(54) REDUCTION OF GRAPHICAL CLUTTER IN COMPUTER DISPLAYS

(76) Inventor: Tobias Haug, Heidelberg (DE)

Correspondence Address: KENYON & KENYON LLP, 1500 K STREET N.W., SUITE 700, WASHINGTON, DC, 20005, US

(21) Appl. No.: 11/613,514

(22) Filed: Dec. 20, 2006

Related U.S. Application Data
(60) Provisional application No. 60/813,614, filed on Dec. 30, 2005.

(51) Int. Cl. G06F 3/048; G06F 17/00

(52) U.S. Cl. 715/835; 715/509; 715/764; 715/777; 715/841

(57) ABSTRACT

Embodiments of the present invention relate to a method and system for reducing graphical clutter in computer displays. According to the embodiments, one or more graphical control elements may be hidden, and only displayed on a computer screen when needed, for example in response to detection of an interactive event with respect to an interactive field of a display.

This application claims the benefit of provisional application 60/813,614, filed Dec. 30, 2005, the contents of which are fully incorporated herein by reference.

### BACKGROUND OF THE INVENTION

Often, computer displays are overloaded with information. The extraneous information can include graphical elements such as “text boxes,” “keys” or “buttons” for invoking drop-down lists, links to outside documents, F4 controls, and the like. All this information may confuse the eye and make a graphical interface difficult to use. Moreover, the information may unnecessarily occupy space in a computer display that could be used for other, more important purposes.

FIG. 1 shows an example of a computer screen display 100 containing information, some of which may be considered extraneous. The display 100 is formatted as a table with a plurality of columns: a Request No. column 101, a Description column 102, a Status column 103, a Date column 104, and a Released column 105. A given row and column define a table “cell.” Some of the cells in table 100 contain both a text box and an action key or button. Specifically, all of the cells in the Status column and the Released column contain both a text box and an action key. A text box, as illustrated in FIG. 1, may be indicated by a well-defined outline or border, heightened or contrasting coloration or brightness, or other distinguishing feature. For example, in the first row of the Status column, a cell 103.1 contains a text box 103.11 and an action key 103.21. The first row of the Released column contains a text box 105.11 and an action button 105.21.

A text box may indicate that interactivity is possible. For example, a text box may indicate that text enclosed therein is changeable by a user. The text might be changeable by simply typing in the text box. Alternatively, the text might be changeable by activating a drop-down list using an associated action button. In table 100, for example, clicking on action button 103.21 might generate a drop-down list, to allow a user to select from among pre-defined options for values to be assigned to the text box. For example, the drop-down list might let a user change the value in text box 103.11 from “Not Completed” to “In Process” or “Completed”. Similarly, a drop-down list generated by clicking action button 105.21 might let a user change the value in text box 105.11 from “No” to “Yes” or vice versa.

Table 100 further comprises a selection column 106 with selection fields 106.1-6. The text boxes and action buttons in table 100 may be inoperative unless a corresponding selection field 106.1-6 is selected. Thus, in the example of FIG. 1, text boxes 103.11 and 105.11, and corresponding action buttons 103.21 and 105.21 are operative, because selection field 106.1 is selected (as indicated by the check mark in the box). The text boxes and action buttons in the second and fourth rows of table 100 are also operative. By contrast, the text boxes and action buttons in the third, fifth and sixth rows are inoperative, because the corresponding selection fields 106.3, 106.5 and 106.6, respectively, are not selected.

In view of the above, it may be appreciated that some of the text boxes and action buttons in table 100 represent graphical clutter. That is, all of the text boxes and action buttons are always displayed, even though all may not be currently needed. In this example, for instance, the display of the text boxes and action buttons in the third, fifth and sixth rows represents extraneous information, since their corresponding selection fields are non-selected and therefore the buttons are inoperative. The table 100 would appear more intelligible and be less confusing to the eye if these extraneous text boxes and action buttons were not displayed. Also, the space conserved by not displaying the extraneous information could be used for other purposes.

### BRIEF DESCRIPTION OF THE DRAWINGS

FIG. 1 shows an example of a prior art computer display with graphical clutter;

FIGS. 2A-2C show examples of a computer display with reduced graphical clutter according to embodiments of the present invention;

FIG. 3 shows a system according to embodiments of the present invention; and

FIG. 4 shows a process flow according to embodiments of the present invention.

### DETAILED DESCRIPTION

Embodiments of the present invention address the above-described concerns. The embodiments relate to a method and system for reducing graphical clutter in computer displays. According to the embodiments, one or more graphical elements for interactivity and control may be hidden, and only displayed on a computer screen when needed, for example in response to an interactive event, such as the selection or activation of a related element or field. The graphical elements may be, for example, fields such as text boxes, or keys or buttons for invoking functionality such as displaying a drop-down list. By only displaying such interactive and control elements when needed, graphical clutter in a computer display may be reduced and the space that is saved may be used for other purposes.

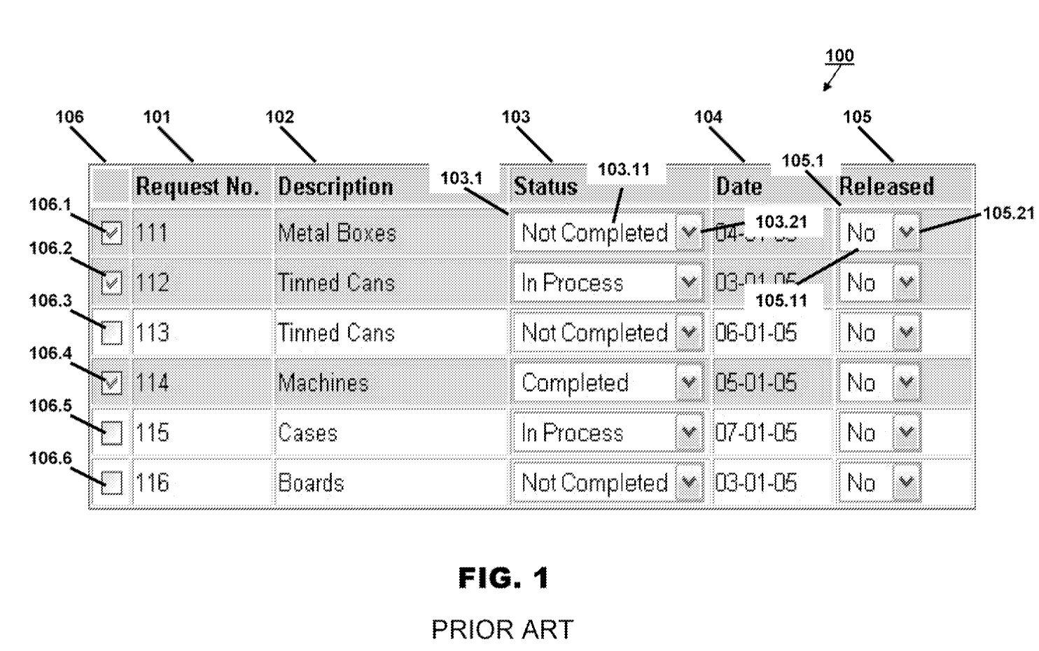

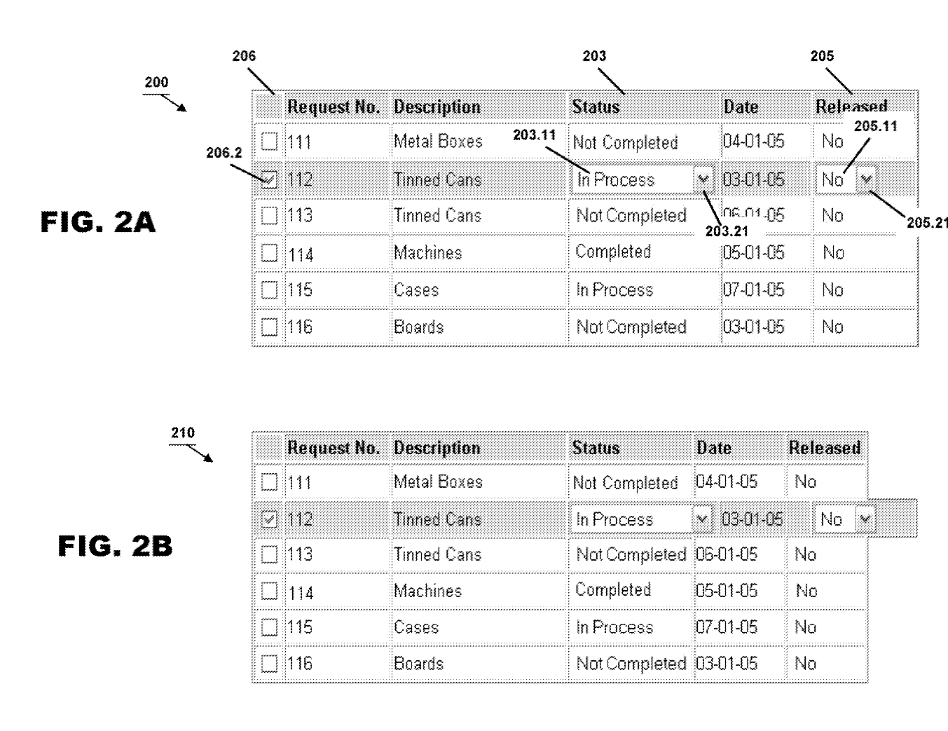

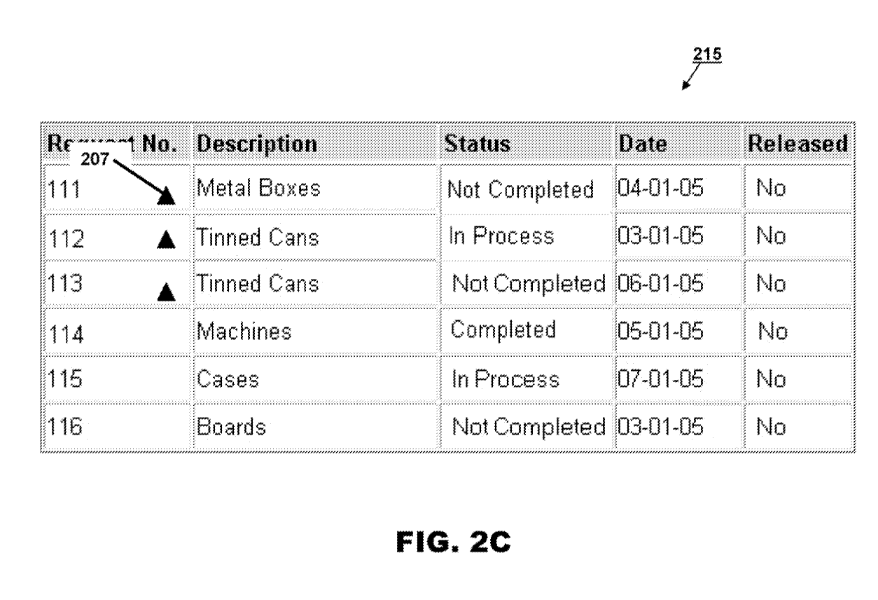

FIG. 2A shows a computer display of a table 200 according to embodiments of the present invention. The table 200 of FIG. 2A appears as a simpler, less cluttered, more readable version of the table 100 of FIG. 1. Like display 100, display 200 is formatted as a table with a plurality of columns: a selection column 206, a Request No. column 201, a Description column 202, a Status column 203, a Date column 204, and a Released column 205. However, the only text boxes and action keys shown are in the second row, because the corresponding selection field 206.2 is selected. Otherwise, the cells of table 200 contain only plain text. Table 200 is therefore less confusing to the eye than table 100.

As illustrated in FIG. 2A, selecting a row may cause hidden controls in the row to be revealed, i.e., rendered visible. A row may be selected by an interactive event, such as clicking on the corresponding selection field. However, the present invention is not limited to this mode of revealing hidden controls; other examples of interactive events that may cause hidden controls to be revealed include a keystroke or combination of keystrokes, or simply causing the cursor or mouse pointer to enter a field of the table 200. Upon de-selection of a row (e.g., by a clicking on selection field 206.2 to toggle the field off), or upon disengagement of a mouse pointer, cursor or other interactive tool from a field of the table 200, the controls may become hidden again.

FIG. 2B shows an example of a table 210 according to an alternative embodiment of the present invention. Table 210 is more compact than table 200, because space that would be otherwise used for graphical control elements is conserved. To reveal hidden graphical control elements in a row, the row may be expanded, as shown in the second row of table 210. This expansion may be temporary; upon de-selection of or disengagement from the row containing the controls, the controls may become hidden again, causing the row to contract again to its original size. Similar operations, of course, may be performed for a column of a table.

The graphical elements that are formatted as action buttons may be able to receive input and cause an operation to be performed in response thereto. The operation may be associated with a related field. For example, along lines discussed previously, clicking on action button 203.21 may generate a drop-down list containing values assignable to the adjacent text box 203.11; clicking on action button 205.21 may generate a drop-down list containing values assignable to the adjacent text box 205.11. However, drop-down list functionality is not the only kind that may be invoked by an action button. Other operations may be implicit or embedded, similarly to the way function keys on a keyboard work.

As noted previously, hidden controls may be revealed in response to an interactive event, such as an input from an input device like a mouse or keyboard. The occurrence of an interactive event with respect to any field of a display may cause hidden controls to be revealed for related fields. Further, according to embodiments of the invention, “hints” or indicators of fields responsive to interactive events to reveal hidden controls may be provided. This is illustrated in FIG. 2C. In FIG. 2C, table 215 includes indicators 207 to indicate that the first three rows of the table have hidden controls. The last three rows, on the other hand, since they lack such indicators, do not have hidden controls and are thus static and unresponsive to interactivity.

A computer display with hidden graphical elements for interactive control as described above may be implemented, for example, at least in part by computer-executable instructions according to embodiments of the present invention. The instructions may generate, possibly in association with conventional code that controls aspects of a display's appearance, a display on a display device, where the display includes hidden graphical control elements. In embodiments, the hidden controls may be included in a tabular display. Each hidden control may be logically linked or associated with one or more related fields in the display, such that an interactive event with respect to the one or more related fields causes the hidden control to be displayed. In a tabular display, the one or more related fields may be a field or fields in a same row, or a same column. A previously-hidden control may become operative upon display, or may require another level of control to become operative, e.g. by way of a selection field 206.2. The features of the invention could be implemented by creating the table in a text layer and then overlaying the text layer with a Diff tag layer that would provide the control.

The instructions according to embodiments of the present invention, or conventional code that interfaces with the instructions, may receive input signals from a mouse, keyboard or other input device and perform corresponding operations. For example, a user may reveal hidden controls by clicking with a mouse on a field in a display according to embodiments, or by causing the mouse pointer to enter or cross the field without clicking, by positioning a cursor over the field, or performing one or more keystrokes. Such operations may generate signals to the instructions, or conventional code that interfaces with the instructions. In response to the signals, the instructions, or conventional code that interfaces with the instructions, may cause one or more previously hidden graphical control elements to appear on the display. The graphical elements, once displayed, may further be rendered operative, i.e., able to receive input and cause an operation to be performed in response thereto, either upon display thereof or after further control operations.

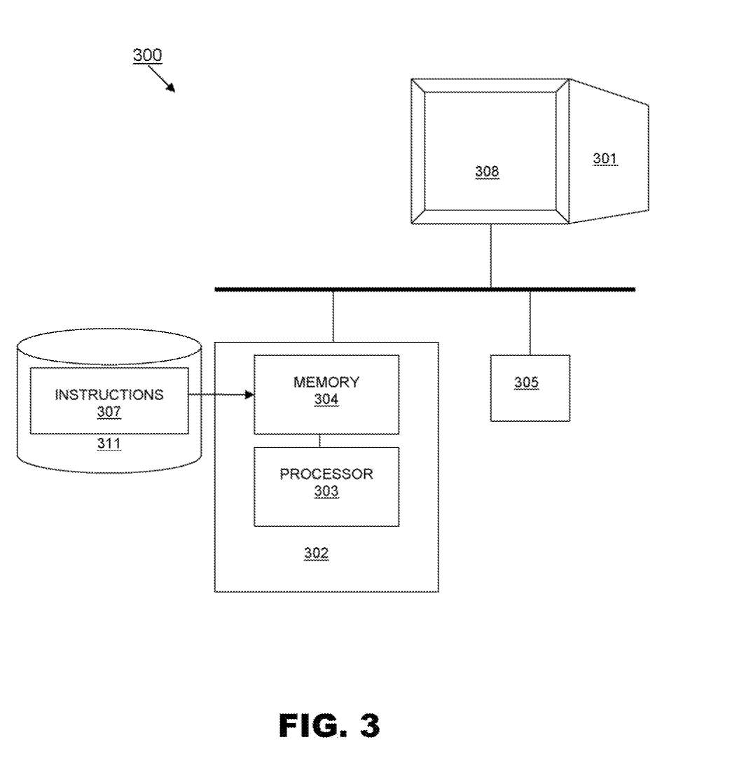

FIG. 3 shows a system 300 wherein embodiments of the present invention may find advantageous application. The system 300 may comprise a display device 301. The display device 301 may be coupled to a computer 302 comprising a processor 303 and memory 304. The computer 302 may further be coupled to an input device 305 such as a mouse or keyboard.

Computer-executable instructions 307 according to embodiments of the present invention may be stored on any machine-readable medium 311, such as RAM (random access memory), ROM (read-only memory), floppy disk, fixed disk, CD-ROM, magnetic tape and the like. The instructions may be loaded from the machine-readable medium 311 into the memory 304 for execution by the processor 303. As noted previously, the instructions may interface with conventional code that controls aspects of a display's appearance.

The instructions 307, or conventional code that interfaces with the instructions 307, may generate a display 308 on the display device 301. The display 308 may include one or more hidden graphical control elements according to embodiments of the present invention. With the input device 305, a user may select or activate a field within the display. This may generate signals from the input device 305 that are detected by the computer 302. The instructions 307, or conventional code that interfaces with the instructions 307, may be responsive to the signals detected by the computer 302 to display a previously-hidden graphical control element. The instructions 307, or conventional code that interfaces with the instructions 307, may further be responsive to an input to the previously-hidden graphical control element, such as a mouse click on the previously-hidden graphical control element, to perform an operation.

In view of the above discussion, embodiments of the present invention further relate to a user interface for a document, and methods of applying the user interface. For example, in a method according to embodiments of the present invention, by way of a user interface, a user may open a document in a computer application program, and display the document contents in an application window. The document contents may comprise a table which includes one or more hidden graphical control elements in rows or columns of the table.

The method may further include providing interactive fields in the table. The interactive fields may be linked to the hidden graphical control elements. Responsive to an interactive event with a given interactive field, a corresponding, previously-hidden graphical control element may be revealed and become operative. In embodiments, the hidden graphical control element may be revealed by expanding the corresponding row or column to accommodate the graphical control element. The expanded row or column may be caused to return to its previous size when the interactive field is no longer engaged.

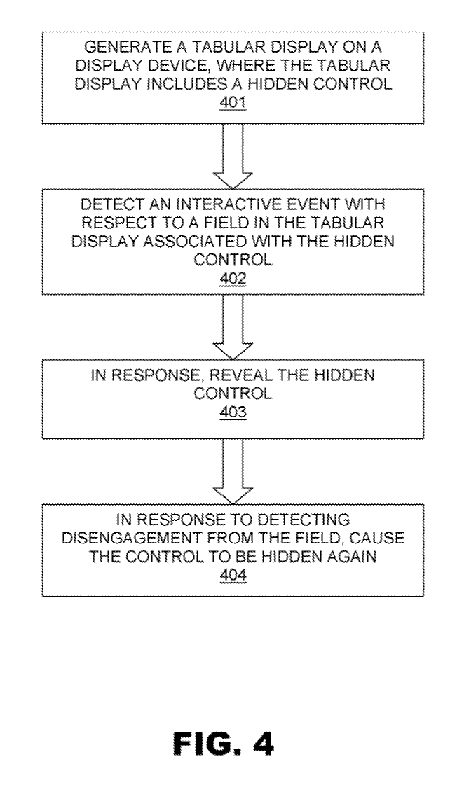

FIG. 4 shows a process flow according to embodiments of the present invention. As shown in block 401, the process may comprise generating a tabular display on a display device, wherein the tabular display includes a hidden control. The process may further comprise detecting an interactive event with respect to a field in the tabular display associated with the hidden control, as shown in block 402. As shown in block 403, in response to the interactive event, the hidden control may be revealed. In response to detecting disengagement from the field, the control may be caused to be hidden again, as shown in block 404.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
generating a tabular display on a display device, the tabular display including a hidden control;
detecting an interactive event with respect to a field in the tabular display associated with the hidden control; and
in response to the interactive event, revealing the hidden control.

2. The method of claim 1, further comprising causing the previously-hidden control, when displayed, to become operative.

3. The method of claim 2, wherein the previously-hidden control, when operative, is responsive to an input to perform an operation.

4. The method of claim 1, wherein revealing the hidden control includes expanding a row or column of the tabular display to display the hidden control.

5. The method of claim 1, further comprising providing an indicator in the field to indicate that the field is responsive to an interactive event to reveal the hidden control.

6. A machine-readable medium storing instructions to perform a method according to claim 1.

7. A system comprising:
a display device; and
a computer coupled to the display device, the computer to generate a display on the display device, the display including a table containing a hidden graphical control element;
wherein the table includes a field responsive to an interactive event to reveal the hidden graphical control element.

8. The system of claim 7, further comprising an input device, the input device to generate signals to the computer indicative of the interactive event.

9. The system of claim 7, wherein the hidden graphical control element further becomes operative upon becoming displayed.

10. The system of claim 7, whether the field further comprises an indicator to indicate that the field is responsive to an interactive event to reveal the hidden control.

11. The system of claim 7, wherein the hidden graphical control element is revealed by expanding a row or column of the table to display the graphical control element.

12. A user interface method for a document, comprising:
opening a document in a computer application program,
displaying document contents in an application window, wherein the document contents include a table;
providing a hidden graphical control element in the table;
providing a interactive field associated with the hidden graphical control element in the table; and
in response to an interactive event with the interactive field, revealing the hidden graphical control element.

13. The user interface method of claim 12, further comprising:
causing the previously-hidden graphical control element to become operative.

14. The user interface method of claim 12, further comprising, upon disengagement with the interactive field, causing the graphical control element to become hidden again.

15. The user interface method of claim 12, wherein the hidden graphical control element is revealed by expanding a row or column of the table to display the graphical control element.

16. A machine-readable medium storing instructions to perform a method according to claim 12.
